(19) United States
(12) Patent Application Publication
(10) Pub. No.: US 2026/0073196 A1
(43) Pub. Date: Mar. 12, 2026

(54) DATA PROCESSING SYSTEM AND DATA PROCESSING METHOD

(71) Applicant: SEMICONDUCTOR ENERGY LABORATORY CO., LTD., Atsugi-shi (JP)

(72) Inventors: Junpei MOMO, Sagamihara (JP); Hiroki HOSOSHIMA, Atsugi (JP)

(21) Appl. No.: 19/313,956

(22) Filed: Aug. 29, 2025

(30) Foreign Application Priority Data
Sep. 6, 2024 (JP) 2024-153587

(51) Int. Cl. G06N 3/0475; G06F 16/332; G06F 40/169

(52) U.S. Cl. CPC G06N 3/0475; G06F 16/332; G06F 40/169; G06F 2216/11

(57) ABSTRACT

A novel data processing system that is highly convenient, useful, or reliable is provided. The data processing system is composed of three components. A component 1 receives identification data, transmits the identification data to a component 3, and provides an annotated document. A component 2 extracts a special technical feature and generates the annotated document with the use of a large language model. The component 3 receives and shares the identification data and the special technical feature, and creates and shares a table. The component 3 includes two subcomponents. A subcomponent 1 manages a patent application document and an examination record with the use of a database and a management system. A subcomponent 2 creates a prompt to extract the special technical feature and generate the annotated document.

### BACKGROUND OF THE INVENTION

### 1. Field of the Invention

One embodiment of the present invention relates to a data processing system, a data processing method, or a semiconductor device.

Note that one embodiment of the present invention is not limited to the above technical field. The technical field of one embodiment of the invention disclosed in this specification and the like relates to an object, a method, or a manufacturing method. One embodiment of the present invention relates to a process, a machine, manufacture, or a composition of matter. Thus, more specifically, examples of the technical field of one embodiment of the present invention disclosed in this specification include a data processing device, a semiconductor device, a memory device, a method for driving any of them, and a method for manufacturing any of them.

### 2. Description of the Related Art

In recent years, language models using neural networks have been actively developed, and especially large language models (LLM) have attracted attention. An LLM is a natural language processing model learned using a large amount of data. With an LLM, for example, an interactive model that gives an answer to a user's instruction can be achieved. In Non-Patent Document 1, generative pre-trained transformer 4 (GPT-4, registered trademark) is disclosed as an LLM, and ChatGPT is disclosed as an interactive model.

By utilizing an LLM, the capability of a natural language processing model has been significantly increased. On the other hand, owing to the expansion of the language model, it is difficult to incorporate and operate a language model on one's own from the aspect of facilities and costs. Accordingly, a language model provided by an external service is generally used.

### REFERENCE

### Non-Patent Document

[Non-Patent Document 1] Summary of ChatGPT/GPT-4 Research and Perspective Towards the Future of Large Language Models, Yiheng Liu et al., (submitted on 4 Apr. 2023) [online], Internet URL: https://arxiv.org/abs/2304.01852

### SUMMARY OF THE INVENTION

An object of one embodiment of the present invention is to provide a novel data processing system that is highly convenient, useful, or reliable. Another object is to provide a novel data processing method that is highly convenient, useful, or reliable. Another object is to provide a novel data processing system, a novel data processing method, or a novel semiconductor device.

Note that the description of these objects does not preclude the existence of other objects. One embodiment of the present invention does not need to achieve all of these objects. Other objects will be apparent from and can be derived from the description of the specification, the drawings, the claims, and the like.

(1) One embodiment of the present invention is a data processing system including a first component, a second component, and a third component.

The first component has a function of receiving identification data and transmitting the identification data to the third component and a function of receiving and providing an annotated document. The identification data includes data specifying one of patent applications.

The second component has a function of receiving a first prompt and transmitting a special technical feature to the third component, a function of receiving a second prompt and transmitting the annotated document to the third component, and a function of performing processing using a large language model. The large language model has a function of extracting the special technical feature in accordance with the first prompt and a function of generating the annotated document in accordance with the second prompt.

The third component has a function of receiving the identification data and the special technical feature and sharing the identification data and the special technical feature in the third component, a function of creating a table and sharing the table in the third component, a function of creating the first prompt and the second prompt and transmitting the first prompt and the second prompt to the second component, and a function of receiving the annotated document and transmitting the annotated document to the first component.

The third component includes a first subcomponent and a second subcomponent.

The first subcomponent has a function of performing processing using a database and a management system. The database includes at least one patent application document and at least one examination record, and the examination record includes a notice of reasons for refusal and an argument. The management system has a function of creating the table from the database in accordance with a query. The table includes the patent application document, a scope of granted patent claims of the patent application document, and the examination record of the scope of the granted patent claims. The query includes the identification data, and requests that an original application of the patent application document is the same as an original application of a patent application specified by the identification data.

The second subcomponent has a function of creating the first prompt and the second prompt. The first prompt includes a first instruction and the table, and the first instruction includes a procedure for extracting the special technical feature of the scope of the granted patent claims from the table. The second prompt includes a second instruction, the special technical feature, and the patent application document, and the second instruction includes a procedure for generating the annotated document by giving decoration or annotation to description of the special technical feature in the patent application document.

Thus, the patent application document whose original application is the same as that of the patent application specified by the identification data can be collected using the identification data from the database. The patent application document, the scope of the granted patent claims of the patent application document, and the examination record of the scope of the granted patent claims can be collected to create the table. The special technical feature of the scope of the granted patent claims can be extracted from the table. The description of the special technical feature included in the patent application document can be given with decoration or annotation. As a result, a novel data processing system that is highly convenient, useful, or reliable can be provided.

(2) Another embodiment of the present invention is the data processing system in which the first component has a function of receiving range data and transmitting the range data to the third component and a function of receiving and providing a summary. The range data specifies a portion of the patent application document.

The second component has a function of receiving a third prompt and transmitting the summary to the third component. The large language model has a function of generating the summary in accordance with the third prompt. The third component has a function of receiving the range data and sharing the range data in the third component, a function of transmitting the third prompt to the second component, and a function of receiving the summary and transmitting the summary to the first component.

The third component includes a third subcomponent. The third subcomponent has a function of extracting a part from the patent application document on the basis of the range data. The second subcomponent has a function of creating the third prompt. The third prompt includes a third instruction and the part, and the third instruction includes a procedure for generating the summary from the part.

Thus, the part can be extracted from the patent application document with the use of the range data. In addition, the summary can be generated from the extracted part. For another example, the summary can be generated from the part extracted from a portion to which decoration or annotation is not given. Moreover, the summary can be generated from description other than the description of the special technical feature of the scope of the granted patent claims. As a result, a novel data processing system that is highly convenient, useful, or reliable can be provided.

(3) Another embodiment of the present invention is the data processing system in which the first component has a function of receiving an undo command and providing the annotated document.

Thus, the user of the data processing system can examine the summary and correct the range data, for example. As a result, a novel data processing system that is highly convenient, useful, or reliable can be provided.

(4) Another embodiment of the present invention is the data processing system in which the first component has a function of receiving acceptance data and transmitting the acceptance data to the third component and a function of receiving and providing a claim draft.

The second component has a function of receiving a fourth prompt and transmitting the claim draft to the third component. The large language model has a function of generating the claim draft in accordance with the fourth prompt.

The third component has a function of receiving the acceptance data and sharing the acceptance data in the third component, a function of transmitting the fourth prompt to the second component, and a function of receiving the claim draft and transmitting the claim draft to the first component. The second subcomponent has a function of creating the fourth prompt. The fourth prompt includes a fourth instruction, the special technical feature, the description of the special technical feature, and the part, and the fourth instruction includes a procedure for generating the claim draft from the special technical feature, the description of the special technical feature, and the part.

Thus, the claim draft can be generated using the special technical feature of the scope of the granted patent claims, the description of the special technical feature, and the part (e.g., the part extracted from a portion to which decoration or annotation is not given). As a result, a novel data processing system that is highly convenient, useful, or reliable can be provided.

(5) Another embodiment of the present invention is the data processing system in which the first component has a function of receiving a requirement and transmitting the requirement to the third component.

The second component has a function of receiving a fifth prompt and transmitting the claim draft to the third component. The large language model has a function of generating the claim draft in accordance with the fifth prompt.

The third component has a function of receiving the requirement and sharing the requirement in the third component and a function of transmitting the fifth prompt to the second component. The second subcomponent has a function of creating the fifth prompt. The fifth prompt includes a fifth instruction, the requirement, the special technical feature, the description of the special technical feature, and the part, and the fifth instruction includes a procedure for generating the claim draft from the requirement, the special technical feature, the description of the special technical feature, and the part.

Thus, the user of the data processing system can examine the claim draft and add the requirement, for example. The claim draft can be generated by adding the requirement to the special technical feature of the scope of the granted patent claims, the description of the special technical feature, and the part (e.g., the part extracted from a portion to which decoration or annotation is not given). As a result, a novel data processing system that is highly convenient, useful, or reliable can be provided.

(6) Another embodiment of the present invention is the data processing system in which the first component includes a display device.

The display device has a function of displaying the annotated document. The description of the special technical feature in the annotated document is displayed while being given with annotation or decoration using at least one of a highlight, a bold letter, an italic letter, and an underline.

Thus, for example, the user of the data processing system can easily recognize the description of the special technical feature. As a result, a novel data processing system that is highly convenient, useful, or reliable can be provided.

(7) Another embodiment of the present invention is the data processing system in which the first component includes a display device and an input device.

The display device has a function of displaying the annotated document and a pointer. The description of the special technical feature in the annotated document is displayed while being given with annotation or decoration using at least one of a highlight, a bold letter, an italic letter, and an underline. The input device has a function of moving the pointer and a function of inputting the range data.

Thus, the user of the data processing system can specify the part to be extracted from the patent application document, for example. As a result, a novel data processing system that is highly convenient, useful, or reliable can be provided.

(8) Another embodiment of the present invention is the data processing system in which the first component, the second component, and the third component each include an arithmetic device and a communication device, and the communication devices are connected to each other via a network.

(9) Another embodiment of the present invention is a data processing method including a first phase. The first phase includes a first step, a second step, a third step, a fourth step, a fifth step, a sixth step, a seventh step, an eighth step, a ninth step, a tenth step, an eleventh step, and a twelfth step.

In the first step of the first phase, a first component receives identification data and transmits the identification data to a second component.

In the second step of the first phase, the second component receives the identification data and shares the identification data in the second component. The second component includes a first subcomponent and a second subcomponent. The first subcomponent has a function of performing processing using a database and a management system. The database includes a patent application document and an examination record, and the examination record includes a notice of reasons for refusal and an argument.

In the third step of the first phase, the first subcomponent creates a table from the database in accordance with a query with use of the management system and shares the table in the second component. The table includes the patent application document, a scope of granted patent claims of the patent application document, and the examination record of the scope of the granted patent claims. The query includes the identification data, and requests that an original application of the patent application document is the same as an original application of a patent application specified by the identification data.

In the fourth step of the first phase, the second subcomponent creates a first prompt and transmits the first prompt to a third component. The first prompt includes a first instruction and the table, and the first instruction includes a procedure for extracting a special technical feature of the scope of the granted patent claims from the table.

In the fifth step of the first phase, the third component receives the first prompt and extracts the special technical feature with use of a large language model.

In the sixth step of the first phase, the third component transmits the special technical feature to the second component.

In the seventh step of the first phase, the second component receives the special technical feature and shares the special technical feature in the second component.

In the eighth step of the first phase, the second subcomponent creates a second prompt and transmits the second prompt to the third component. The second prompt includes a second instruction, the special technical feature, and the patent application document, and the second instruction includes a procedure for generating an annotated document by giving decoration or annotation to description of the special technical feature in the patent application document.

In the ninth step of the first phase, the third component receives the second prompt and generates the annotated document with use of the large language model.

In the tenth step of the first phase, the third component transmits the annotated document to the second component.

In the eleventh step of the first phase, the second component receives the annotated document and transmits the annotated document to the first component.

In the twelfth step of the first phase, the first component receives and provides the annotated document.

Thus, the patent application document whose original application is the same as that of the patent application specified by the identification data can be collected using the identification data from the database. The patent application document, the scope of the granted patent claims of the patent application document, and the examination record of the scope of the granted patent claims can be collected to create the table. The special technical feature of the scope of the granted patent claims can be extracted from the table. The description of the special technical feature included in the patent application document can be given with decoration or annotation. As a result, a novel data processing method that is highly convenient, useful, or reliable can be provided.

(10) Another embodiment of the present invention is a data processing method including the first phase and a second phase. The second phase follows the first phase, and includes a first step, a second step, a third step, a fourth step, a fifth step, a sixth step, a seventh step, an eighth step, a ninth step, and a tenth step.

In the first step of the second phase, the first component receives range data and transmits the range data to the second component. The range data specifies a portion of the patent application document.

In the second step of the second phase, the second component receives the range data and shares the range data in the second component. The second component includes a third subcomponent.

In the third step of the second phase, the third subcomponent extracts a part from the patent application document on the basis of the range data.

In the fourth step of the second phase, the second subcomponent creates a third prompt and transmits the third prompt to the third component. The third prompt includes a third instruction and the part, and the third instruction includes a procedure for generating a summary from the part.

In the fifth step of the second phase, the third component receives the third prompt and generates the summary with use of the large language model.

In the sixth step of the second phase, the third component transmits the summary to the second component.

In the seventh step of the second phase, the second component receives the summary and transmits the summary to the first component.

In the eighth step of the second phase, the first component receives and provides the summary.

In the ninth step of the second phase, the first component receives first acceptance data or an undo command and transmits the first acceptance data or the undo command to the second component.

In the tenth step of the second phase, the second phase ends when the second component receives the first acceptance data, and a process proceeds to the first step of the second phase when the second component receives the undo command.

Thus, the part can be extracted from the patent application document with the use of the range data. In addition, the summary can be generated from the extracted part. For another example, the summary can be generated from the part extracted from a portion to which decoration or annotation is not given. Moreover, the summary can be generated from description other than the description of the special technical feature of the scope of the granted patent claims. As a result, a novel data processing method that is highly convenient, useful, or reliable can be provided.

(11) Another embodiment of the present invention is a data processing method including the first phase, the second phase, and a third phase. The third phase follows the second phase, and includes a first step, a second step, a third step, a fourth step, a fifth step, a sixth step, a seventh step, an eighth step, and a ninth step.

In the first step of the third phase, the second subcomponent creates a fourth prompt and transmits the fourth prompt to the third component. The fourth prompt includes a fourth instruction, the special technical feature, the description of the special technical feature, and the part, and the fourth instruction includes a procedure for generating a claim draft from the special technical feature, the description of the special technical feature, and the part.

In the second step of the third phase, the third component receives the fourth prompt or a fifth prompt and generates the claim draft with use of the large language model.

In the third step of the third phase, the third component transmits the claim draft to the second component.

In the fourth step of the third phase, the second component receives the claim draft and transmits the claim draft to the first component.

In the fifth step of the third phase, the first component receives and provides the claim draft.

In the sixth step of the third phase, the first component receives second acceptance data or a requirement and transmits the second acceptance data or the requirement to the second component.

In the seventh step of the third phase, the third phase ends when the second component receives the second acceptance data, and the second subcomponent creates the fifth prompt and transmits the fifth prompt to the third component when the second component receives the requirement. The fifth prompt includes a fifth instruction, the requirement, the special technical feature, and the part, and the fifth instruction includes a procedure for generating the claim draft from the requirement, the special technical feature, and the part.

In the eighth step of the third phase, the third component receives the fifth prompt and generates the claim draft with use of the large language model.

In the ninth step of the third phase, the third component transmits the claim draft to the second component, and a process proceeds to the fourth step of the third phase.

Thus, the claim draft can be generated using the special technical feature of the scope of the granted patent claims and the part. For example, the user of the data processing system can examine the claim draft and add the requirement. The claim draft can be generated by adding the requirement to the special technical feature of the scope of the granted patent claims and the part. As a result, a novel data processing method that is highly convenient, useful, or reliable can be provided.

One embodiment of the present invention can provide a novel data processing system that is highly convenient, useful, or reliable. Alternatively, a novel data processing method that is highly convenient, useful, or reliable can be provided. Alternatively, a novel data processing system, a novel data processing method, or a novel semiconductor device can be provided.

Note that the description of these effects does not preclude the existence of other effects. One embodiment of the present invention does not need to have all of these effects. Other effects will be apparent from and can be derived from the description of the specification, the drawings, the claims, and the like.

### BRIEF DESCRIPTION OF THE DRAWINGS

FIG. 1 illustrates a structure of a data processing system of an embodiment.

FIG. 2 illustrates a structure of a component used in a data processing system of an embodiment.

FIGS. 3A and 3B illustrate a structure of a component used in a data processing system of an embodiment.

FIGS. 4A and 4B illustrate structures of prompts used in a data processing system of an embodiment.

FIG. 5A illustrates a structure of an annotated document used in a data processing system of an embodiment, and FIG. 5B illustrates a structure of a display device that can be used for the data processing system of an embodiment.

FIG. 6 illustrates a structure of a data processing system of an embodiment.

FIG. 7 illustrates a structure of a component used in a data processing system of an embodiment.

FIG. 8 illustrates a structure of a prompt used in a data processing system of an embodiment.

FIG. 9A illustrates a structure of a display device that can be used for a data processing system of an embodiment, and FIG. 9B illustrates structures of the display device and an input device that can be used for the data processing system of an embodiment.

FIG. 10 illustrates a structure of a data processing system of an embodiment.

FIG. 11 illustrates a structure of a component used in a data processing system of an embodiment.

FIGS. 12A and 12B illustrate structures of prompts used in a data processing system of an embodiment.

FIG. 13 illustrates a structure of a data processing device used for a data processing system of an embodiment.

FIG. 14 shows a data processing method of an embodiment.

FIG. 15 shows a data processing method of an embodiment.

FIG. 16 shows a data processing method of an embodiment.

FIG. 17 shows a data processing method of an embodiment.

FIG. 18 shows a data processing method of an embodiment.

FIG. 19 shows a data processing method of an embodiment.

### DETAILED DESCRIPTION OF THE INVENTION

One embodiment of the present invention is a data processing system including a first component, a second component, and a third component.

The first component has a function of receiving identification data and transmitting the identification data to the third component and a function of receiving and providing an annotated document. The identification data includes data specifying one of patent applications.

The second component has a function of receiving a first prompt and transmitting a special technical feature to the third component, a function of receiving a second prompt and transmitting the annotated document to the third component, and a function of performing processing using a large language model. The large language model has a function of extracting the special technical feature in accordance with the first prompt and a function of generating the annotated document in accordance with the second prompt.

The third component has a function of receiving the identification data and the special technical feature and sharing the identification data and the special technical feature in the third component, a function of creating a table and sharing the table in the third component, a function of creating the first prompt and the second prompt and transmitting the first prompt and the second prompt to the second component, and a function of receiving the annotated document and transmitting the annotated document to the first component. The third component includes a first subcomponent and a second subcomponent.

The first subcomponent has a function of performing processing using a database and a management system. The database includes a patent application document and an examination record, and the examination record includes a notice of reasons for refusal and an argument. The management system has a function of creating the table from the database in accordance with a query. The table includes the patent application document, a scope of granted patent claims of the patent application document, and the examination record of the scope of the granted patent claims. The query includes the identification data. The query requests that an original application of the patent application document is the same as an original application of a patent application specified by the identification data.

The second subcomponent has a function of creating the first prompt and the second prompt. The first prompt includes a first instruction and the table, and the first instruction includes a procedure for extracting the special technical feature of the scope of the granted patent claims from the table. The second prompt includes a second instruction, the special technical feature, and the patent application document, and the second instruction includes a procedure for generating the annotated document by giving decoration or annotation to description of the special technical feature in the patent application document.

Thus, the patent application document whose original application is the same as that of the patent application specified by the identification data can be collected using the identification data from the database. The patent application document, the scope of the granted patent claims of the patent application document, and the examination record of the scope of the granted patent claims can be collected to create the table. The special technical feature of the scope of the granted patent claims can be extracted from the table. The description of the special technical feature included in the patent application document can be given with decoration or annotation. As a result, a novel data processing system that is highly convenient, useful, or reliable can be provided.

Embodiments will be described in detail with reference to the drawings. Note that the present invention is not limited to the following description, and it will be readily appreciated by those skilled in the art that modes and details of the present invention can be modified in various ways without departing from the spirit and scope of the present invention. Thus, the present invention should not be construed as being limited to the description in the following embodiments. Note that in structures of the invention described below, the same portions or portions having similar functions are denoted by the same reference numerals in different drawings, and the description thereof is not repeated.

Ordinal numbers such as “first” and “second” in this specification and the like are used in order to avoid confusion among components. Thus, the terms do not limit the number of components or the order of components (e.g., the order of steps or the stacking order of layers). A term without an ordinal number in this specification and the like may be described with an ordinal number in a claim in order to avoid confusion among components. A term with an ordinal number in this specification and the like may be described with a different ordinal number in a claim. A term with an ordinal number in this specification and the like may be described without an ordinal number in a claim.

Although a block diagram in which components are classified by their functions and shown as independent blocks is shown in the drawing attached to this specification, it is difficult to completely separate actual components according to their functions and one component can relate to a plurality of functions.

### Embodiment 1

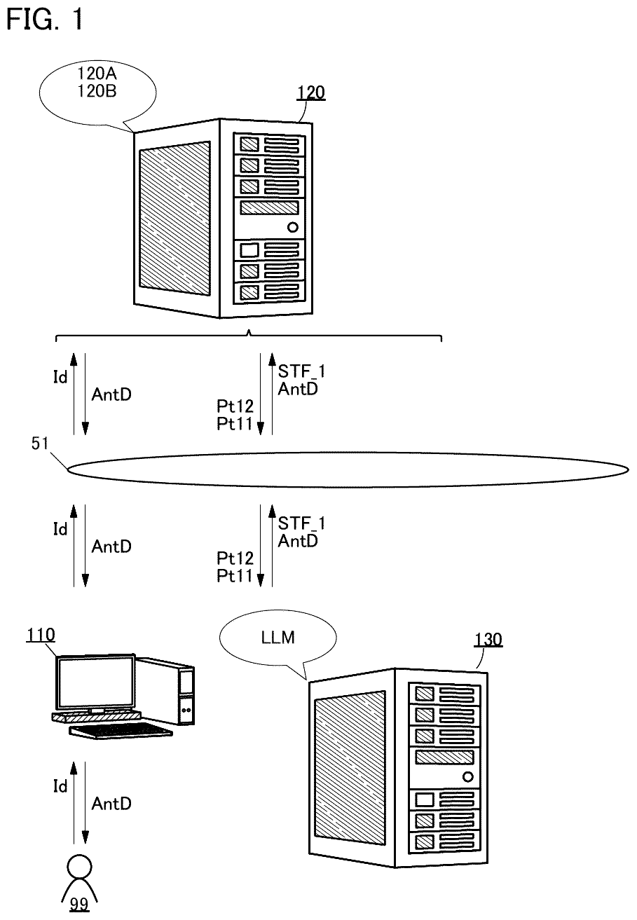

In this embodiment, a data processing system of one embodiment of the present invention will be described with reference to FIG. 1 to FIG. 13.

FIG. 1 illustrates a structure of a data processing system of one embodiment of the present invention.

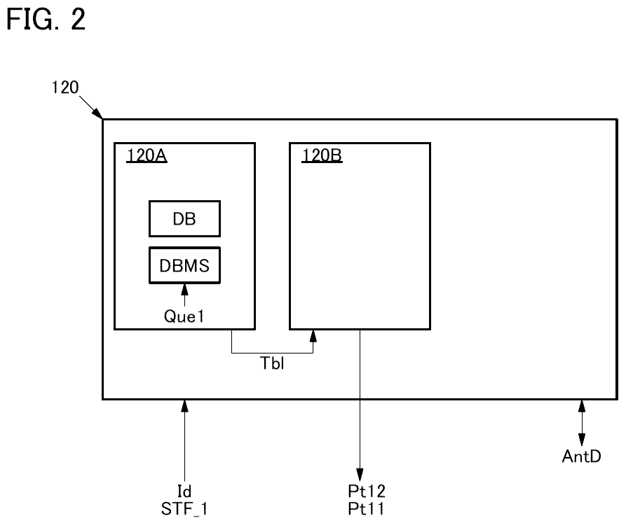

FIG. 2 illustrates a structure of a component used in the data processing system of one embodiment of the present invention.

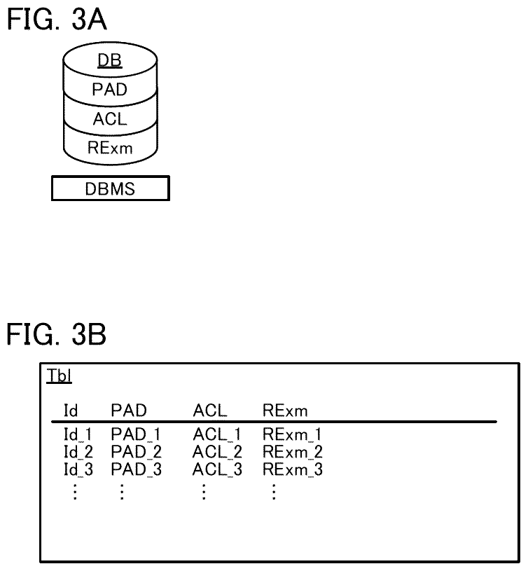

FIG. 3A illustrates a structure of a database used in the data processing system of one embodiment of the present invention, and FIG. 3B illustrates a structure of a table used in the data processing system of one embodiment of the present invention.

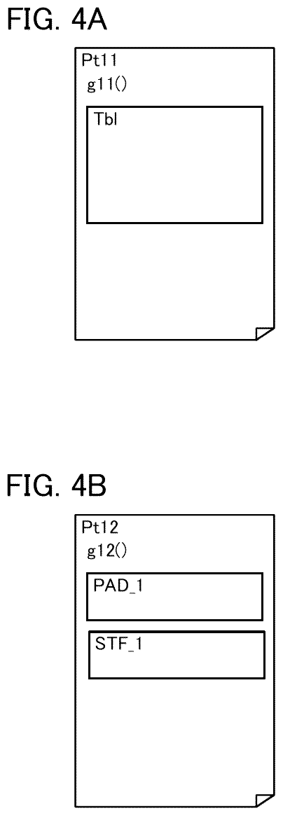

FIGS. 4A and 4B each illustrate a structure of a prompt transmitted and received in the data processing system of one embodiment of the present invention.

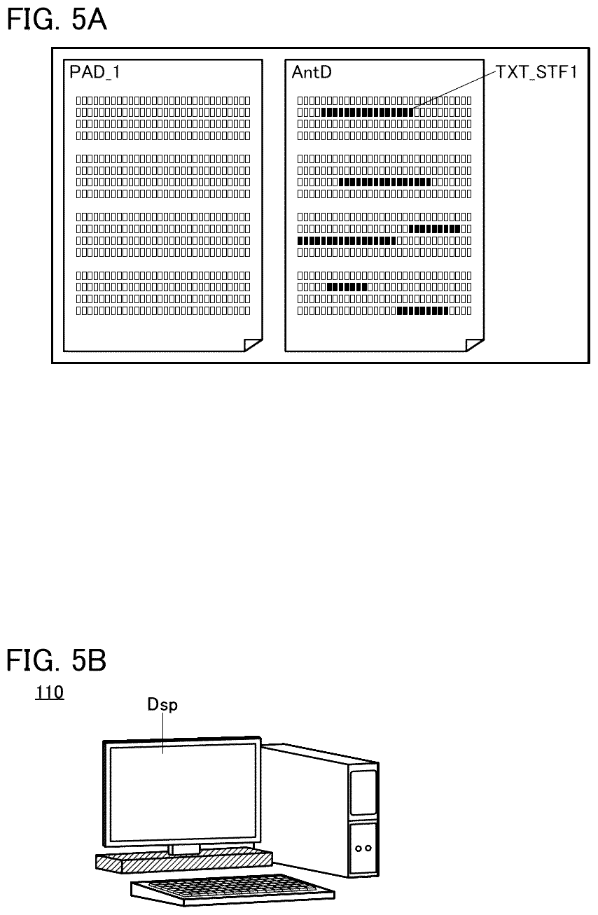

FIG. 5A illustrates a structure of an annotated document provided by the data processing system of one embodiment of the present invention, and FIG. 5B illustrates a structure of a display device that can be used for the data processing system of one embodiment of the present invention.

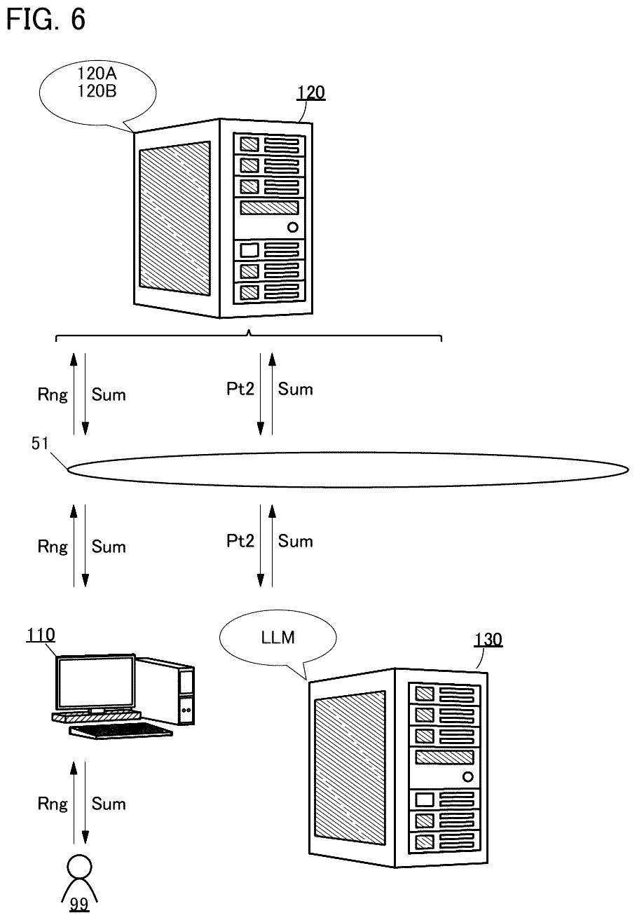

FIG. 6 illustrates a structure of the data processing system of one embodiment of the present invention.

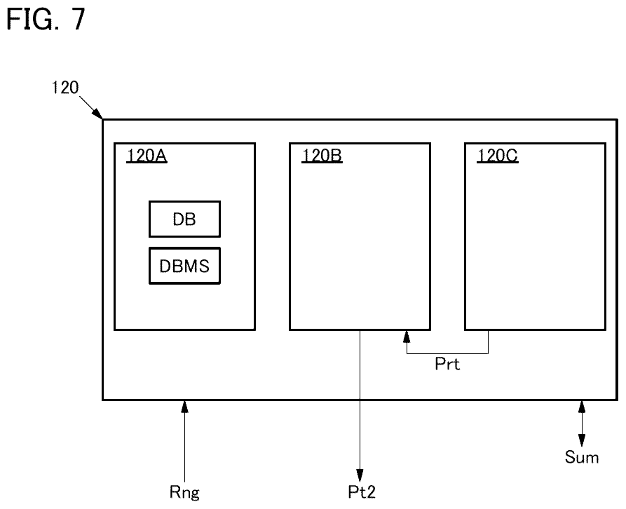

FIG. 7 illustrates a structure of the component used in the data processing system of one embodiment of the present invention.

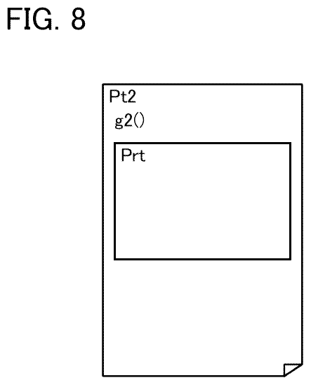

FIG. 8 illustrates a structure of a prompt transmitted and received in the data processing system of one embodiment of the present invention.

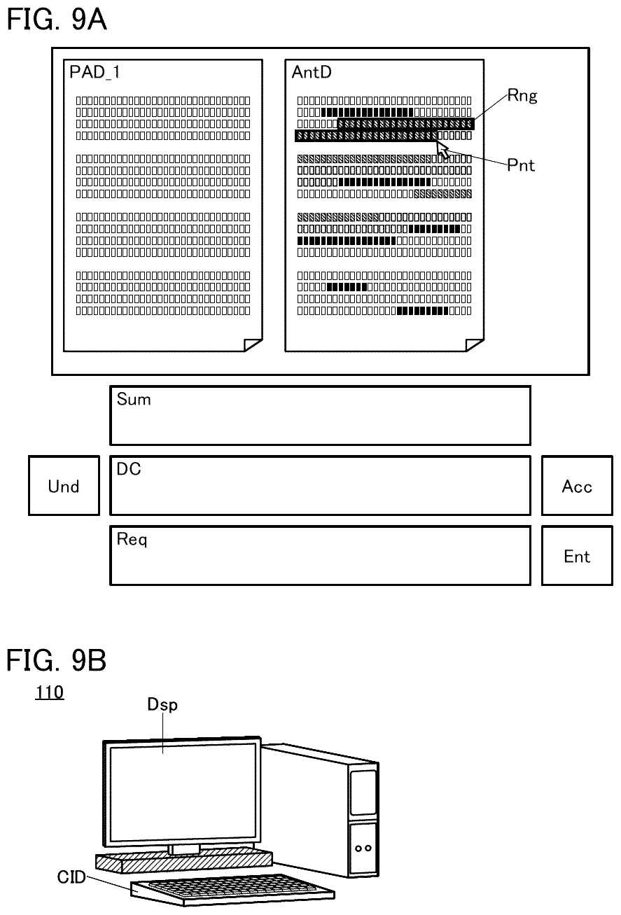

FIG. 9A illustrates a structure of a user interface provided by the data processing system of one embodiment of the present invention, and FIG. 9B illustrates structures of the display device and an input device that can be used for the data processing system of one embodiment of the present invention.

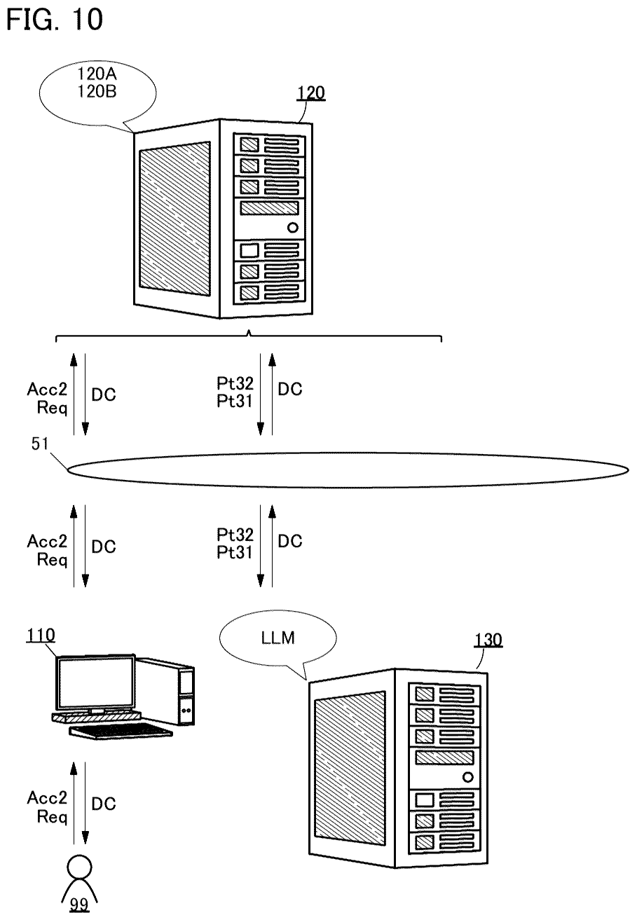

FIG. 10 illustrates a structure of the data processing system of one embodiment of the present invention.

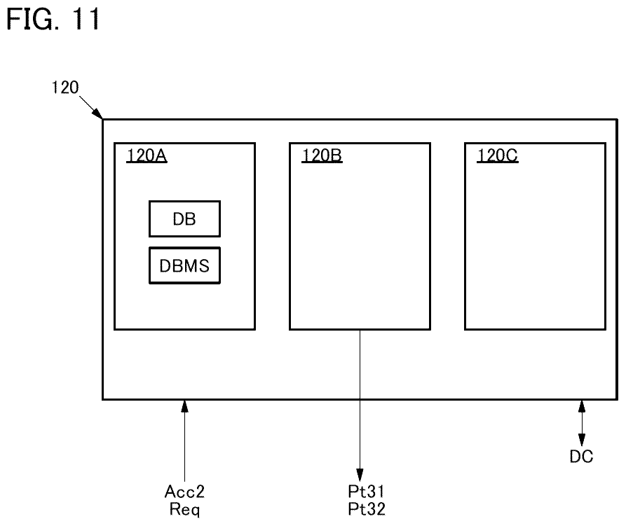

FIG. 11 illustrates a structure of the component used in the data processing system of one embodiment of the present invention.

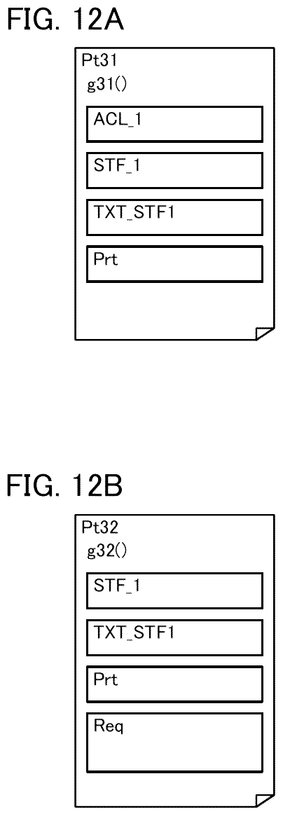

FIGS. 12A and 12B illustrate structures of prompts transmitted and received in the data processing system of one embodiment of the present invention.

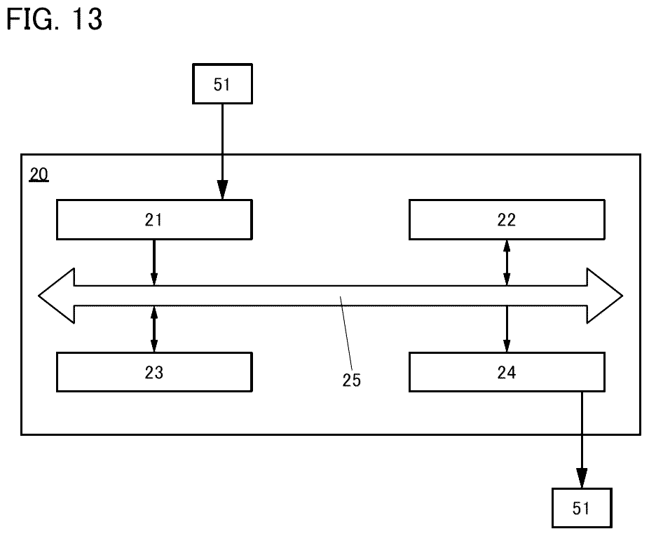

FIG. 13 is a block diagram illustrating a structure of a data processing device that can be used for the data processing system of one embodiment of the present invention.

### Structure Example 1 of Data Processing System

The data processing system described in this embodiment includes a component 110, a component 130, and a component 120 (see FIG. 1).

A data processing device having a function of the component 110, a data processing device having a function of the component 130, and a data processing device having a function of the component 120 each include an arithmetic device and a communication device. The communication devices can be connected to each other via a network 51, for example, to construct the data processing system of one embodiment of the present invention.

### Structure Example 1 of Component 110

The component 110 has a function of receiving identification data Id and transmitting it to the component 120, and a function of receiving an annotated document AntD and providing it to a user 99 of the data processing system, for example.

Note that the identification data Id includes data specifying one of patent applications. For example, an identification number for identifying an applicant, an application number, a reference number, or the like can be used as the identification data Id. Thus, one of patent applications can be specified using one piece of the identification data Id.

For example, the user 99 of the data processing system inputs the identification data Id to the component 110. Specifically, the user 99 of the data processing system inputs the identification data Id to the component 110 with the use of an input device such as a keyboard, a mouse, an eye-gaze input device, or a microphone.

### Structure Example 1 of Component 130

The component 130 has a function of receiving a prompt Pt11 and transmitting a special technical feature STF_1 to the component 120, and a function of receiving a prompt Pt12 and transmitting the annotated document AntD to the component 120. The component 130 also has a function of performing processing using a large language model LLM.

### Structure Example 1 of Large Language Model LLM

The large language model LLM has a function of extracting the special technical feature STF_1 in accordance with the prompt Pt11. The large language model LLM also has a function of generating the annotated document AntD in accordance with the prompt Pt12. Note that a technical feature that clearly shows contribution of an invention to the prior art, e.g., technical significance of the invention in comparison with the prior art, can be used as the special technical feature STF_1.

### Structure Example 1 of Component 120

The component 120 has a function of receiving the identification data Id and the special technical feature STF_1 and sharing them in the component 120.

The component 120 also has a function of creating a table Tbl and sharing it in the component 120, a function of creating the prompt Pt11 and the prompt Pt12 and transmitting them to the component 130, and a function of receiving the annotated document AntD and transmitting it to the component 110.

Note that the component 120 includes a subcomponent 120A and a subcomponent 120B (see FIG. 2).

### Structure Example of Subcomponent 120A

The subcomponent 120A has a function of performing processing using a database DB and a management system DBMS.

### Structure Example of Database DB

The database DB includes a region PAD, a region ACL, and a region RExm (see FIG. 3A). Note that the region PAD includes a patent application document PAD_1, the region ACL includes a scope of granted patent claims ACL_1, and the region RExm includes an examination record RExm_1. The patent application document PAD_1 includes the scope of the granted patent claims ACL_1, and the examination record RExm_1 includes a notice of reasons for refusal and an argument.

### Structure Example of Management System DBMS

The management system DBMS has a function of creating the table Tbl from the database DB in accordance with a query Que1.

The query Que1 includes the identification data Id, and requests that the original application of the patent application document PAD_1 is the same as that of a patent application specified by the identification data Id. For example, in the case where a patent application specified by the identification data Id is a divisional application, the query Que1 requests all the applications divided from the original application of the patent application specified by the identification data Id. The query Que1 can also request applications filed to other countries or regions on the basis of the original application of the patent application specified by the identification data Id. In other words, the query Que1 can request all the family applications. Note that the identification data Id can be assigned to a template prepared in advance to be used for the query Que1.

The table Tbl includes the patent application document PAD_1, the scope of the granted patent claims ACL_1 of the patent application document PAD_1, and the examination record RExm_1 of the scope of the granted patent claims ACL_1 (see FIG. 3B). Note that the patent application document PAD_1 specified by identification data Id_1, a patent application document PAD_2 specified by identification data Id_2, and a patent application document PAD_3 specified by identification data Id_3 originate from the same application.

### Structure Example 1 of Subcomponent 120B

The subcomponent 120B has a function of creating the prompt Pt11 and the prompt Pt12.

### Structure Example of Prompt Pt11

The prompt Pt11 includes an instruction g11( ) and the table Tbl (see FIG. 4A).

The instruction g11( ) includes a procedure for extracting the special technical feature STF_1 of the scope of the granted patent claims ACL_1 from the table Tbl.

For example, text in the next paragraph can be used as the prompt Pt11.
“Table: {{table Tbl}}
Please extract the special technical feature of the scope of allowed claims from the table.”

### Structure Example of Prompt Pt12

The prompt Pt12 includes an instruction g12( ), the special technical feature STF_1, and the patent application document PAD_1 (see FIG. 4B).

The instruction g12( ) includes a procedure for generating the annotated document AntD by giving decoration or annotation to description of the special technical feature TXT_STF1 included in the patent application document PAD_1.

For example, text in the next paragraph can be used as the prompt Pt12.
“Special technical feature: {{special technical feature STF_1}}
Patent specification: {{patent application document PAD_1}}
Please wrap a portion explaining the special technical feature in the description of the patent specification with the following tags.
Tag: <span class=“stf”></span>”

### Structure Example of Annotated Document AntD

The annotated document AntD includes the patent application document PAD_1 and decoration or annotation (see FIG. 5A). For example, the description of the special technical feature TXT_STF1 can be given with decoration to be used for the annotated document AntD. Specifically, at least one of a highlight, a bold letter, an italic letter, an underline, and the like can be used as letter decoration. In addition, the description of the special technical feature TXT_STF1 can be given with annotation to be used for the annotated document AntD. Specifically, a speech bubble or the like can be used as the annotation. Note that the subcomponent 120B can store the description of the special technical feature TXT_STF1.

A region where the annotated document AntD is displayed and a region where the patent application document PAD_1 is displayed can be provided side by side.

Thus, the patent application document PAD_1 whose original application is the same as that of the patent application specified by the identification data Id can be collected using the identification data Id from the database DB. The patent application document PAD_1, the scope of the granted patent claims ACL_1 of the patent application document PAD_1, and the examination record RExm_1 of the scope of the granted patent claims ACL_1 can be collected to create the table Tbl. The special technical feature STF_1 of the scope of the granted patent claims ACL_1 can be extracted from the table Tbl. The description of the special technical feature TXT_STF1 included in the patent application document PAD_1 can be given with decoration or annotation. As a result, a novel data processing system that is highly convenient, useful, or reliable can be provided.

### Structure Example 2 of Component 110

The component 110 includes a display device Dsp (see FIG. 5B). The display device Dsp has a function of displaying the annotated document AntD. Note that the description of the special technical feature TXT_STF1 included in the annotated document AntD is displayed while being given with annotation or decoration using at least one of a highlight, a bold letter, an italic letter, an underline, and the like.

Thus, for example, the user of the data processing system can easily recognize the description of the special technical feature TXT_STF1. As a result, a novel data processing system that is highly convenient, useful, or reliable can be provided.

### Structure Example 3 of Component 110

The component 110 has a function of receiving range data Rng and transmitting it to the component 120, and a function of receiving a summary Sum and providing it to the user 99 of the data processing system, for example (see FIG. 6). The range data Rng specifies part of the patent application document PAD_1.

Note that the user 99 of the data processing system inputs the range data Rng to the component 110, for example. Specifically, the user 99 of the data processing system inputs the range data Rng to the component 110 with the use of an input device such as a keyboard, a mouse, or an eye-gaze input device. For example, the user 99 of the data processing system can supply the range data Rng to a portion of the patent application document PAD_1 to which decoration or annotation is not given, so that the portion can be specified.

### Structure Example 2 of Component 130

The component 130 has a function of receiving a prompt Pt2 and transmitting the summary Sum to the component 120.

### Structure Example 2 of Large Language Model LLM

The large language model LLM has a function of generating the summary Sum in accordance with the prompt Pt2.

### Structure Example 2 of Component 120

The component 120 has a function of receiving the range data Rng and sharing it in the component 120, a function of transmitting the prompt Pt2 to the component 130, and a function of receiving the summary Sum and transmitting it to the component 110. The component 120 includes a subcomponent 120C (see FIG. 7).

### Structure Example of Subcomponent 120C

The subcomponent 120C has a function of extracting a part Prt from the patent application document PAD_1 on the basis of the range data Rng.

### Structure Example 2 of Subcomponent 120B

The subcomponent 120B has a function of creating the prompt Pt2.

### Structure Example of Prompt Pt2

The prompt Pt2 includes an instruction g2( ) and the part Prt (see FIG. 8). The instruction g2( ) includes a procedure for generating the summary Sum from the part Prt.

For example, text in the next paragraph can be used as the prompt Pt2.
“Text: {{part Prt}}
Please create the summary of the text.”

Thus, the part Prt can be extracted from the patent application document PAD_1 with the use of the range data Rng. In addition, the summary Sum can be generated from the extracted part Prt. For another example, the summary Sum can be generated from the part Prt extracted from a portion to which decoration or annotation is not given. Moreover, the summary Sum can be generated from description other than the description of the special technical feature STF_1 of the scope of the granted patent claims ACL_1. As a result, a novel data processing system that is highly convenient, useful, or reliable can be provided.

### Structure Example 4 of Component 110

The component 110 includes the display device Dsp and an input device CID (see FIG. 9B). The display device Dsp has a function of displaying the annotated document AntD, the summary Sum, and a pointer Pnt (see FIG. 9A). Note that the description of the special technical feature TXT_STF1 included in the annotated document AntD is displayed while being given with annotation or decoration using at least one of a highlight, a bold letter, an italic letter, an underline, and the like. The input device CID has a function of moving the pointer Pnt and a function of inputting the range data Rng.

Thus, the user of the data processing system can specify the part Prt to be extracted from the patent application document PAD_1, for example. As a result, a novel data processing system that is highly convenient, useful, or reliable can be provided.

### Structure Example 5 of Component 110

The component 110 has a function of receiving an undo command Und and providing the annotated document AntD to the user 99 of the data processing system, for example (see FIG. 9A).

For example, the user 99 of the data processing system inputs the undo command Und to the component 110. Specifically, the user 99 of the data processing system inputs the undo command Und to the component 110 with the use of the input device CID such as a keyboard, a mouse, or an eye-gaze input device (see FIG. 9B).

For example, the component 110 can provide a region where the undo command Und is input and a region where acceptance data Acc2 is input (see FIG. 9A).

Thus, the user of the data processing system can examine the summary Sum and correct the range data Rng, for example. As a result, a novel data processing system that is highly convenient, useful, or reliable can be provided.

### Structure Example 6 of Component 110

The component 110 has a function of receiving the acceptance data Acc2 and transmitting it to the component 120, and a function of receiving a claim draft DC and providing it to the user 99 of the data processing system, for example (see FIG. 10).

For example, the user 99 of the data processing system inputs the acceptance data Acc2 to the component 110. Specifically, the user 99 of the data processing system inputs the acceptance data Acc2 to the component 110 with the use of an input device such as a keyboard, a mouse, or an eye-gaze input device.

### Structure Example 3 of Component 130

The component 130 has a function of receiving a prompt Pt31 and transmitting the claim draft DC to the component 120.

### Structure Example 3 of Large Language Model LLM

The large language model LLM has a function of generating the claim draft DC in accordance with the prompt Pt31.

### Structure Example 3 of Component 120

The component 120 has a function of receiving the acceptance data Acc2 and sharing it in the component 120, a function of transmitting the prompt Pt31 to the component 130, and a function of receiving the claim draft DC and transmitting it to the component 110 (see FIG. 10).

### Structure Example 3 of Subcomponent 120B

The subcomponent 120B has a function of creating the prompt Pt31.

### Structure Example of Prompt Pt31

The prompt Pt31 includes an instruction g31( ), the scope of the granted patent claims ACL_1, the special technical feature STF_1, the description of the special technical feature TXT_STF1, and the part Prt (see FIG. 12A).

The instruction g31( ) includes a procedure for generating the claim draft DC from the special technical feature STF_1, the description of the special technical feature TXT_STF1, and the part Prt.

For example, text in the next paragraph can be used as the prompt Pt31.
“Allowed claim: {{scope of granted patent claims ACL_1}}
Allowed matter: {{special technical feature STF_1}}
Support for allowed matter: {{description of special technical feature TXT_STF1}}
Description of feature to be added: {{part Prt}}
Please create new claims from the description of the features to be added with a focus on the allowed matter with reference to the allowed claims.”

Thus, the claim draft DC can be generated using the special technical feature STF_1 of the scope of the granted patent claims ACL_1, the description of the special technical feature TXT_STF1, and the part Prt extracted from a portion to which decoration or annotation is not given, for example. As a result, a novel data processing system that is highly convenient, useful, or reliable can be provided.

### Structure Example 7 of Component 110

The component 110 has a function of receiving a requirement Req and transmitting it to the component 120. For example, the user 99 of the data processing system can input, to the component 110, the requirement Req that is assumed to be insufficient in the claim draft DC.

### Structure Example 4 of Component 130

The component 130 has a function of receiving a prompt Pt32 and transmitting the claim draft DC to the component 120.

### Structure Example 4 of Large Language Model LLM

The large language model LLM has a function of generating the claim draft DC in accordance with the prompt Pt32.

### Structure Example 4 of Component 120

The component 120 has a function of receiving the requirement Req and sharing it in the component 120, and a function of transmitting the prompt Pt32 to the component 130.

### Structure Example 4 of Subcomponent 120B

The subcomponent 120B has a function of creating the prompt Pt32.

### Structure Example of Prompt Pt32

The prompt Pt32 includes an instruction g32( ), the requirement Req, the special technical feature STF_1, the description of the special technical feature TXT_STF1, and the part Prt (see FIG. 12B).

The instruction g32( ) includes a procedure for generating the claim draft DC from the requirement Req, the special technical feature STF_1, the description of the special technical feature TXT_STF1, and the part Prt.

For example, text in the next paragraph can be used as the prompt Pt32.
“Claim under consideration: {{claim draft DC}}
Allowed matter: {{special technical feature STF_1}}
Support for allowed matter: {{description of special technical feature TXT_STF1}}
Description of feature to be added: {{part Prt}}
Comment: {{requirement Req}}
Please revise the claims under consideration with reference to the comment.”

Thus, the user of the data processing system can examine the claim draft DC and add the requirement Req, for example. The claim draft DC can be generated by adding the requirement Req to the special technical feature STF_1 of the scope of the granted patent claims ACL_1, the description of the special technical feature TXT_STF1, and the part Prt extracted from a portion to which decoration or annotation is not given, for example. As a result, a novel data processing system that is highly convenient, useful, or reliable can be provided.

### Structure Example 8 of Component 110

The component 110 has a function of receiving the requirement Req (see FIG. 9A).

For example, the user 99 of the data processing system inputs the requirement Req to the component 110. Specifically, the user 99 of the data processing system inputs the requirement Req to the component 110 with the use of the input device CID such as a keyboard, a mouse, or an eye-gaze input device (see FIG. 9B).

For example, the component 110 can provide a region where the requirement Req is input and a region Ent where a transmission instruction is input (see FIG. 9A).

Thus, the user of the data processing system can examine the summary Sum and correct the range data Rng, for example. As a result, a novel data processing system that is highly convenient, useful, or reliable can be provided.

### Structure Example 2 of Data Processing System

Another data processing system described in this embodiment includes the component 110, the component 120, and the component 130 (see FIG. 1).

The data processing system of one embodiment of the present invention can be composed of a data processing device having a function of the component 110, a data processing device having a function of the component 120, and a data processing device having a function of the component 130, for example. Note that the number of data processing devices constituting the data processing system of one embodiment of the present invention is one or more. For example, a plurality of data processing devices can be connected to each other using the network 51 to construct the data processing system of one embodiment of the present invention.

When the data processing system of one embodiment of the present invention is composed of the plurality of data processing devices, loads relating to data processing can be dispersed.

### Structure Example 1 of Data Processing Device

The data processing device with a structure example 1 described in this embodiment can be used as the component 110. The data processing device with the structure example 1 can be referred to as a client computer or the like. For example, a desktop computer can be used as the component 110.

The data processing device with the structure example 1 can receive data input by the user of the data processing system of one embodiment of the present invention. The data processing device with the structure example 1 can provide data output from the data processing system of one embodiment of the present invention to the user.

For example, dedicated application software or a web browser operates in the component 110. Via either of them, the user of the data processing system of one embodiment of the present invention can access the data processing system. Thus, the user can receive service using the data processing system of one embodiment of the present invention.

### Structure Example 2 of Data Processing Device

The data processing device with a structure example 2 described in this embodiment can be used as the component 120. For example, a workstation, a server computer, or a supercomputer can be used as the component 120.

The data processing device with the structure example 2 preferably has a function of a parallel computer. When the data processing device with this structure is used as a parallel computer, large-scale computation necessary for artificial intelligence (AI) learning and inference can be performed, for example.

Furthermore, the data processing device with the structure example 2 can perform processing using a natural language model with the use of AI.

For example, it is preferable that the data processing device be capable of performing processing using a natural language model such as GPT-3 (registered trademark), GPT-3.5, GPT-4 (registered trademark), LaMDA, Llama2, or Llama3.

### Structure Example 3 of Data Processing Device

The data processing device with a structure example 3 described in this embodiment can be used as the component 130, for example. Note that the component 130 has a larger scale and higher computational capability than the component 120. For example, a large computer such as a server computer or a supercomputer can be used as the component 130.

The data processing device with the structure example 3 preferably has a function of a parallel computer. When the data processing device with this structure is used as a parallel computer, large-scale computation necessary for AI learning and inference can be performed, for example.

Furthermore, the data processing device with the structure example 3 can perform processing using a natural language model with the use of AI. In particular, it is possible to perform processing using a general-purpose language model capable of performing a variety of natural language processing tasks.

For example, processing using a natural language model such as GPT-3 (registered trademark), GPT-3.5, GPT-4 (registered trademark), LaMDA, Llama2, or Llama3 can be performed. In particular, it is preferable that processing using GPT-4 (registered trademark) be available. For example, processing using a language model that is larger in scale than a conventional natural language model can achieve more natural text generation, interaction, or the like.

Note that a service provider using the data processing system of one embodiment of the present invention does not necessarily have its own data processing device with the structure example 3. For example, a service provider can utilize part of the service that another company or the like provides using the data processing device with the structure example 3.

### Structure Example of Network 51

The network 51 that can be used for the data processing system of one embodiment of the present invention can connect the plurality of data processing devices to each other. Thus, the plurality of data processing devices connected to each other can transmit and receive data to and from each other. Furthermore, loads of the data processing can be dispersed.

Note that for wireless communication, it is possible to use, as a communication protocol or a communication technology, a communication standard such as the fourth-generation mobile communication system (4G), the fifth-generation mobile communication system (5G), or the sixth-generation mobile communication system (6G), or a communication standard developed by IEEE such as Wi-Fi (registered trademark) or Bluetooth (registered trademark).

For example, a local network can be used as the network 51. An intranet or an extranet can also be used as the network 51. For another example, a personal area network (PAN), a local area network (LAN), a campus area network (CAN), a metropolitan area network (MAN), a wide area network (WAN), or a global area network (GAN) can be used as the network 51.

For example, a global network can be used as the network 51. Specifically, the Internet, which is an infrastructure of the World Wide Web (WWW), can be used.

Furthermore, the service provider using the data processing system of one embodiment of the present invention can provide service using a data processing method of one embodiment of the present invention via the network 51, for example.

In the case where the data processing system of one embodiment of the present invention is constructed in a local network, the possibility of leakage of confidential information can be lower than that in the case of using the Internet, for example.

### Structure Example 4 of Data Processing Device

A data processing device 20 that can be used for the data processing system of one embodiment of the present invention includes, for example, an input unit 21, a storage unit 22, a processing unit 23, an output unit 24, and a transmission path 25 (see FIG. 13).

Although a block diagram in which components are classified by their functions and shown as independent blocks is shown in the drawing attached to this specification, it is difficult to completely separate actual components according to their functions and one component can relate to a plurality of functions. For example, part of the processing unit 23 functions as the input unit 21 in some cases. In addition, one function can relate to a plurality of components. For example, processing performed in the processing unit 23 is sometimes executed by a different data processing device depending on the processing.

### <<Input Unit 21>>

The input unit 21 can receive data from the outside of the data processing device. For example, the input unit 21 receives data via the network 51. Specifically, a device such as a personal computer having a communication port or a communication function can be used.

The input unit 21 supplies the received data to one or both of the storage unit 22 and the processing unit 23 via the transmission path 25.

### <<Storage Unit 22>>

The storage unit 22 has a function of storing a program to be executed by the processing unit 23. The storage unit 22 can also have a function of storing data generated by the processing unit 23 (e.g., an arithmetic operation result, an analysis result, or an inference result), data received by the input unit 21, and the like.

The storage unit 22 can include a database. The data processing device can include a database in addition to the storage unit 22. The data processing device can have a function of extracting data from a database outside the storage unit 22, the data processing device, or the data processing system. Alternatively, the data processing device can have a function of extracting data from both of its own database and an external database.

One or both of a storage and a file server can be used as the storage unit 22. In addition, a database in which a path of a file stored in the file server is recorded can be used as the storage unit 22.

The storage unit 22 includes at least one of a volatile memory and a nonvolatile memory. Examples of the volatile memory include a dynamic random access memory (DRAM) and a static random access memory (SRAM). Examples of the nonvolatile memory include a resistive random access memory (ReRAM, also referred to as a resistance-change memory), a phase change random access memory (PRAM), a ferroelectric random access memory (FeRAM), a magnetoresistive random access memory (MRAM, also referred to as a magnetoresistive memory), and a flash memory. The storage unit 22 can include at least one of a NOSRAM (registered trademark) and a DOSRAM (registered trademark). The storage unit 22 can include a storage media drive. Examples of the storage media drive include a hard disk drive (HDD) and a solid state drive (SSD).

Note that the NOSRAM is an abbreviation for “nonvolatile oxide semiconductor random access memory (RAM)”. The NOSRAM refers to a memory in which a 2-transistor (2T) or 3-transistor (3T) gain cell is used as a memory cell and the transistor includes a metal oxide in its channel formation region (such a transistor is also referred to as an OS transistor). The OS transistor has an extremely low current that flows between a source and a drain in an off state, that is, an extremely low leakage current. The NOSRAM retains electric charge corresponding to data in memory cells by utilizing characteristics of extremely low leakage current, thereby capable of being used as a nonvolatile memory. In particular, the NOSRAM is capable of reading retained data without destruction (non-destructive reading), and thus is suitable for arithmetic processing in which only data reading operations are repeated many times. The NOSRAM can have large data capacity when stacked in layers, and thus, a semiconductor device in which the NOSRAM is used for a large-scale cache memory, a large-scale main memory, or a large-scale storage memory can have higher performance.

The DOSRAM is an abbreviation for “dynamic oxide semiconductor RAM” and refers to a RAM including a one-transistor (1T) and one-capacitor (IC) memory cell. The DOSRAM is a DRAM formed using an OS transistor and temporarily stores data sent from the outside. The DOSRAM is a memory utilizing a low off-state current of an OS transistor.

In this specification and the like, a metal oxide means an oxide of a metal in a broad sense. Metal oxides are classified into an oxide insulator, an oxide conductor (including a transparent oxide conductor), an oxide semiconductor (also simply referred to as an OS), and the like. For example, in the case where a metal oxide is used in a semiconductor layer of a transistor, the metal oxide is referred to as an oxide semiconductor in some cases.

The metal oxide included in the channel formation region preferably contains indium (In). When the metal oxide included in the channel formation region is a metal oxide containing indium, the carrier mobility (electron mobility) of the OS transistor is high. For example, indium oxide (InOₓ) or indium gallium zinc oxide (In—Ga—Zn oxide, also referred to as “IGZO”) can be used for the channel formation region. The metal oxide included in the channel formation region is preferably an oxide semiconductor containing an element M. The element M is preferably at least one of aluminum (Al), gallium (Ga), and tin (Sn). Other elements that can be used as the element M are boron (B), silicon (Si), titanium (Ti), iron (Fe), nickel (Ni), germanium (Ge), yttrium (Y), zirconium (Zr), molybdenum (Mo), lanthanum (La), cerium (Ce), neodymium (Nd), hafnium (Hf), tantalum (Ta), tungsten (W), and the like. Note that a combination of two or more of the above elements may be used as the element M. The element M is, for example, an element that has high bonding energy with oxygen. The element M is, for example, an element that has higher bonding energy with oxygen than indium is. The metal oxide included in the channel formation region is preferably a metal oxide containing zinc (Zn). The metal oxide containing zinc is easily crystallized in some cases.

The metal oxide included in the channel formation region is not limited to the metal oxide containing indium. The metal oxide included in the channel formation region may be, for example, a metal oxide that does not contain indium but contains any of zinc, gallium, and tin (e.g., zinc tin oxide and gallium tin oxide).

### <<Processing Unit 23>>

The processing unit 23 has a function of performing processing such as arithmetic operation, analysis, and inference with the use of data supplied from one or both of the input unit 21 and the storage unit 22. The processing unit 23 can supply generated data (e.g., an arithmetic operation result, an analysis result, or an inference result) to one or both of the storage unit 22 and the output unit 24.

The processing unit 23 has a function of obtaining data from the storage unit 22. The processing unit 23 can also have a function of storing or registering data in the storage unit 22.

The processing unit 23 can include an arithmetic circuit, for example. The processing unit 23 can include, for example, a central processing unit (CPU). The processing unit 23 can also include a graphics processing unit (GPU). Furthermore, the processing unit 23 can include a neural processing unit/neural network processing unit (NPU).

The processing unit 23 can include a microprocessor such as a digital signal processor (DSP). The microprocessor can be achieved with a programmable logic device (PLD) such as a field programmable gate array (FPGA) or a field programmable analog array (FPAA). The processing unit 23 can also include a quantum processor. The processing unit 23 can interpret and execute instructions from various programs with the use of a processor to process various kinds of data and control programs. The programs to be executed by the processor are stored in at least one of the storage unit 22 and a memory region of the processor.

The processing unit 23 can include a main memory. The main memory includes at least one of a volatile memory such as RAM and a nonvolatile memory such as a read only memory (ROM). The main memory can include at least one of the above-described NOSRAM and DOSRAM.

Examples of the RAM include a DRAM and an SRAM; a virtual memory space is assigned and utilized as a working space of the processing unit 23. An operating system, an application program, a program module, program data, a look-up table, and the like which are stored in the storage unit 22 are loaded into the RAM for execution. The data, program, and program module which are loaded into the RAM are each directly accessed and operated by the processing unit 23.

The ROM can store a basic input/output system (BIOS), firmware, and the like for which rewriting is not needed. Examples of the ROM include a mask ROM, a one-time programmable read only memory (OTPROM), and an erasable programmable read only memory (EPROM). Examples of the EPROM include an ultra-violet erasable programmable read only memory (UV-EPROM) which can erase stored data by irradiation with ultraviolet rays, an electrically erasable programmable read only memory (EEPROM), and a flash memory.

The processing unit 23 can include one or both of an OS transistor and a transistor containing silicon in its channel formation region (Si transistor).

The processing unit 23 preferably includes an OS transistor. Since the OS transistor has an extremely low off-state current, a long data retention period can be ensured with the use of the OS transistor as a switch for retaining electric charge (data) that has flowed into a capacitor functioning as a memory element. When this feature is imparted to at least one of a register and a cache memory included in the processing unit, the processing unit can be operated only when needed, and otherwise can be off while data processed immediately before turning off the processing unit is stored in the memory element. In other words, normally-off computing is possible and the power consumption of the data processing system can be reduced.

The data processing device preferably uses AI for at least part of its processing.

In particular, the data processing device preferably uses an artificial neural network (ANN, hereinafter also simply referred to as a neural network). The neural network is constructed with circuits (hardware) or programs (software).

In this specification and the like, the neural network indicates a general model having the capability of solving problems, which is modeled on a biological neural network and determines the connection strength of neurons by learning. The neural network includes an input layer, an intermediate layer (hidden layer), and an output layer.

In the description of the neural network in this specification and the like, determining a connection strength of neurons (also referred to as weight coefficients) from the existing information is referred to as “learning” in some cases.

In this specification and the like, drawing a new conclusion from a neural network formed with the connection strength obtained by learning is referred to as “inference” in some cases.

### <<Output Unit 24>>

The output unit 24 can output at least one of an arithmetic operation result, an analysis result, and an inference result in the processing unit 23 to the outside of the data processing device. For example, the output unit 24 can transmit data via the network 51. Specifically, a device such as a personal computer having a communication port or a communication function can be used. Furthermore, a device having a communication function may be used as the input unit 21 and the output unit 24.

### <<Transmission Path 25>>

The transmission path 25 has a function of transmitting data. Data transmission and reception between the input unit 21, the storage unit 22, the processing unit 23, and the output unit 24 can be performed via the transmission path 25. Specifically, a LAN or the Internet can be used.

Note that this embodiment can be combined with the other embodiment in this specification as appropriate.

### Embodiment 2

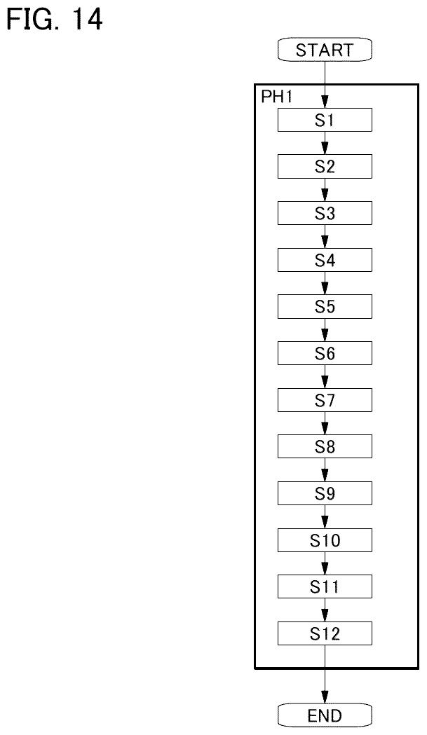

In this embodiment, a data processing method of one embodiment of the present invention will be described with reference to FIG. 14 to FIG. 19.

FIG. 14 is a flowchart showing a data processing method of one embodiment of the present invention.

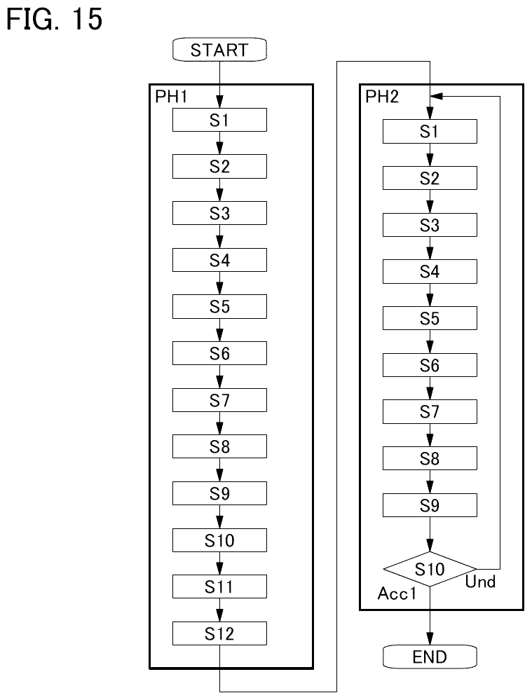

FIG. 15 is a flowchart showing a data processing method of one embodiment of the present invention.

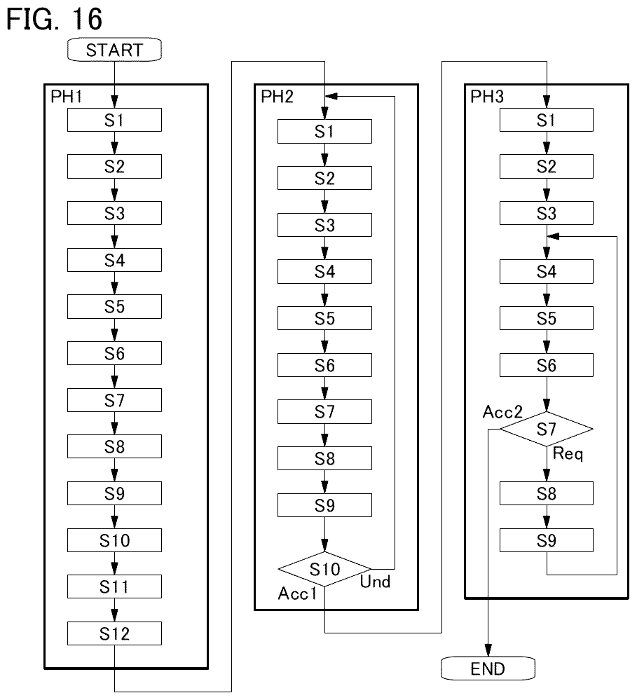

FIG. 16 is a flowchart showing a data processing method of one embodiment of the present invention.

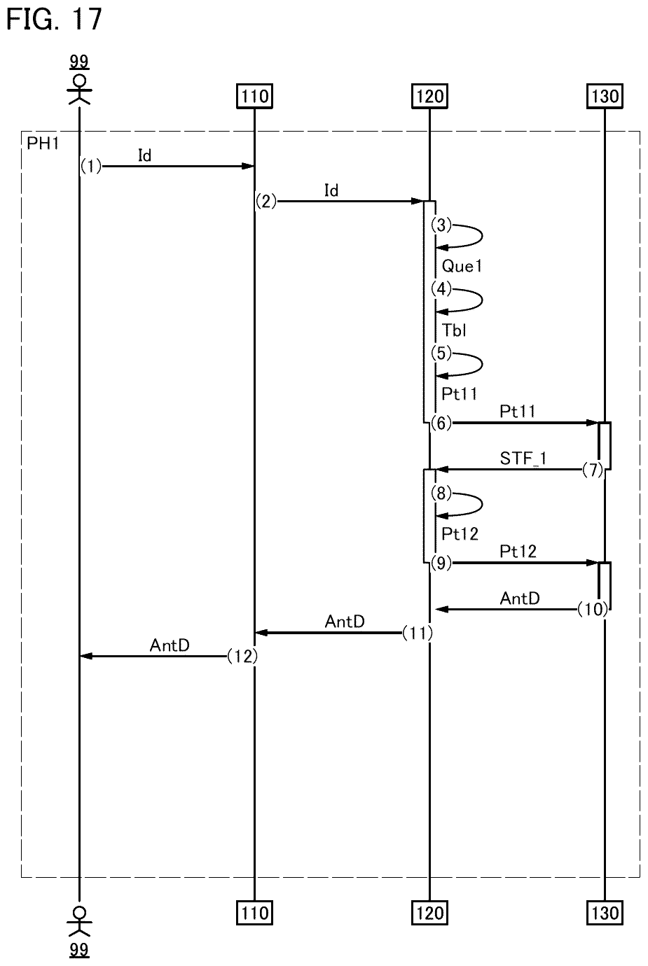

FIG. 17 is a sequence diagram showing a data processing method of one embodiment of the present invention.

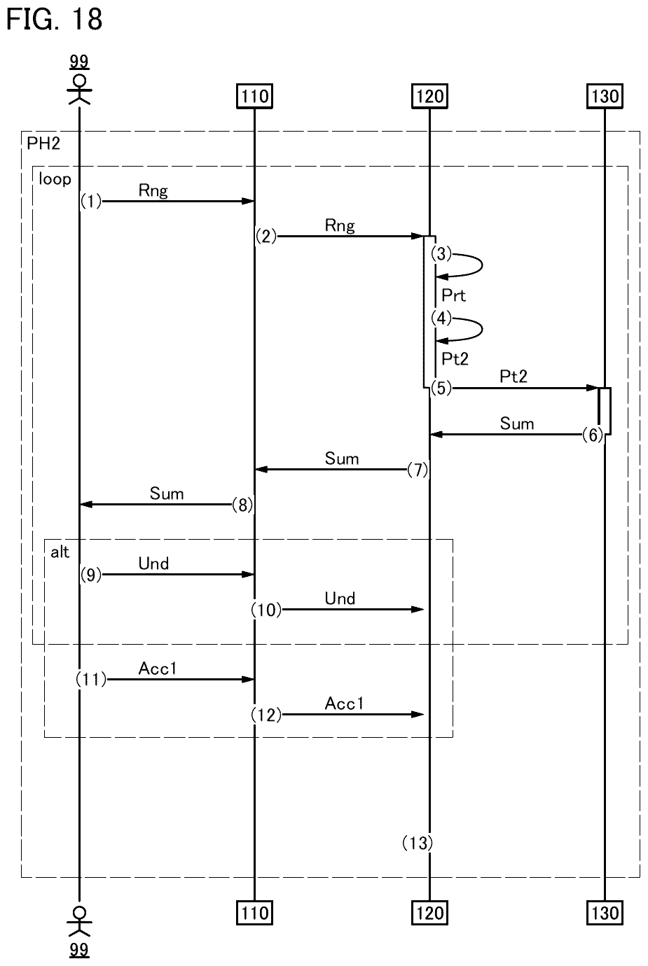

FIG. 18 is a sequence diagram showing a data processing method of one embodiment of the present invention.

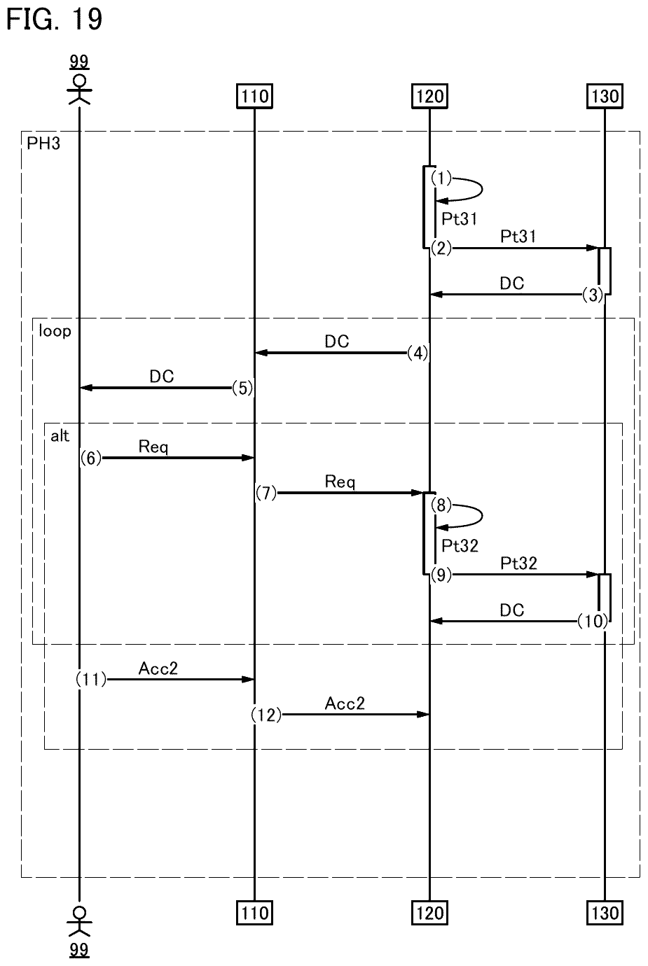

FIG. 19 is a sequence diagram showing a data processing method of one embodiment of the present invention.

### Example 1 of Data Processing Method

The data processing method of one embodiment of the present invention includes Phase PH1 (see FIG. 14 and FIG. 17).

### Example of Phase PH1

Phase PH1 includes Step S1 to Step S12 (see FIG. 14).

### <<Step S1>>

In Step S1 of Phase PH1, the component 110 receives the identification data Id and transmits it to the component 120. For example, the user 99 of the data processing system inputs the identification data Id. Step S1 corresponds to an arrow extending from (1) and an arrow extending from (2) in FIG. 17.

### <<Step S2>>

In Step S2 of Phase PH1, the component 120 receives the identification data Id and shares it in the component 120. The component 120 includes the subcomponent 120A and the subcomponent 120B.

The subcomponent 120A has a function of performing processing using the database DB and the management system DBMS. The database DB includes the patent application document PAD_1 and the examination record RExm_1, and the examination record RExm_1 includes a notice of reasons for refusal and an argument.

### <<Step S3>>

In Step S3 of Phase PH1, the subcomponent 120A creates the table Tbl from the database DB in accordance with the query Que1 with the use of the management system DBMS and shares the table Tbl in the component 120. Step S3 corresponds to an arrow extending from (3) and an arrow extending from (4) in FIG. 17.

The table Tbl includes the patent application document PAD_1, the scope of the granted patent claims ACL_1 of the patent application document PAD_1, and the examination record RExm_1 of the scope of the granted patent claims ACL_1. The query Que1 includes the identification data Id, and requests that the original application of the patent application document PAD_1 is the same as that of a patent application specified by the identification data Id.

### <<Step S4>>

In Step S4 of Phase PH1, the subcomponent 120B creates the prompt Pt11 and transmits it to the component 130. The prompt Pt11 includes the instruction g11( ) and the table Tbl. The instruction g101 includes the procedure for extracting the special technical feature STF_1 of the scope of the granted patent claims ACL_1 from the table Tbl. Step S4 corresponds to an arrow extending from (5) and an arrow extending from (6) in FIG. 17.

### <<Step S5>>

In Step S5 of Phase PH1, the component 130 receives the prompt Pt11 and extracts the special technical feature STF_1 with the use of the large language model LLM.

### <<Step S6>>

In Step S6 of Phase PH1, the component 130 transmits the special technical feature STF_1 to the component 120. Step S6 corresponds to an arrow extending from (7) in FIG. 17.

### <<Step S7>>

In Step S7 of Phase PH1, the component 120 receives the special technical feature STF_1 and shares it in the component 120.

### <<Step S8>>

In Step S8 of Phase PH1, the subcomponent 120B creates the prompt Pt12 and transmits it to the component 130. The prompt Pt12 includes the instruction g12( ), the special technical feature STF_1, and the patent application document PAD_1. The instruction g12( ) includes the procedure for generating the annotated document AntD by giving decoration or annotation to the description of the special technical feature TXT_STF1 included in the patent application document PAD_1. Step S8 corresponds to an arrow extending from (8) and an arrow extending from (9) in FIG. 17.

### <<Step S9>>

In Step S9 of Phase PH1, the component 130 receives the prompt Pt12 and generates the annotated document AntD with the use of the large language model LLM.

### <<Step S10>>

In Step S10 of Phase PH1, the component 130 transmits the annotated document AntD to the component 120. Step S10 corresponds to an arrow extending from (10) in FIG. 17.

### <<Step S11>>

In Step S11 of Phase PH1, the component 120 receives the annotated document AntD and transmits it to the component 110. Step S11 corresponds to an arrow extending from (11) in FIG. 17.

### <<Step S12>>

In Step S12 of Phase PH1, the component 110 receives the annotated document AntD and provides it to the user of the data processing system, for example. Step S12 corresponds to an arrow extending from (12) in FIG. 17.

Thus, the patent application document PAD_1 whose original application is the same as that of the patent application specified by the identification data Id can be collected using the identification data Id from the database DB. The patent application document PAD_1, the scope of the granted patent claims ACL_1 of the patent application document PAD_1, and the examination record RExm_1 of the scope of the granted patent claims ACL_1 can be collected to create the table Tbl. The special technical feature STF_1 of the scope of the granted patent claims ACL_1 can be extracted from the table Tbl. The description of the special technical feature TXT_STF1 included in the patent application document PAD_1 can be given with decoration or annotation. As a result, a novel data processing method that is highly convenient, useful, or reliable can be provided.

### Example 2 of Data Processing Method

Another data processing method of one embodiment of the present invention includes Phase PH1 and Phase PH2 (see FIG. 15 and FIG. 18).

### Example of Phase PH2

Phase PH2 follows Phase PH1, and includes Step S1 to Step S10 (see FIG. 15).

### <<Step S1>>

In Step S1 of Phase PH2, the component 110 receives the range data Rng and transmits it to the component 120. Note that the range data Rng specifies part of the patent application document PAD_1. For example, the user 99 of the data processing system inputs the range data Rng. Step S1 corresponds to an arrow extending from (1) and an arrow extending from (2) in FIG. 18. Some of Step S1 to Step S10 correspond to a portion surrounded by a rectangle loop in FIG. 18.

### <<Step S2>>

In Step S2 of Phase PH2, the component 120 receives the range data Rng and shares it in the component 120. The component 120 includes the subcomponent 120C.

### <<Step S3>>

In Step S3 of Phase PH2, the subcomponent 120C extracts the part Prt from the patent application document PAD_1 on the basis of the range data Rng. Step S3 corresponds to an arrow extending from (3) in FIG. 18.

### <<Step S4>>

In Step S4 of Phase PH2, the subcomponent 120B creates the prompt Pt2 and transmits it to the component 130. The prompt Pt2 includes the instruction g2( ) and the part Prt. The instruction g2( ) includes the procedure for generating the summary Sum from the part Prt. Step S4 corresponds to an arrow extending from (4) and an arrow extending from (5) in FIG. 18.

### <<Step S5>>

In Step S5 of Phase PH2, the component 130 receives the prompt Pt2 and generates the summary Sum with the use of the large language model LLM.

### <<Step S6>>

In Step S6 of Phase PH2, the component 130 transmits the summary Sum to the component 120. Step S6 corresponds to an arrow extending from (6) in FIG. 18.

### <<Step S7>>

In Step S7 of Phase PH2, the component 120 receives the summary Sum and transmits it to the component 110. Step S7 corresponds to an arrow extending from (7) in FIG. 18.

### <<Step S8>>

In Step S8 of Phase PH2, the component 110 receives the summary Sum and provides it to the user of the data processing system, for example. Step S8 corresponds to an arrow extending from (8) in FIG. 18.

### <<Step S9>>

In Step S9 of Phase PH2, the component 110 receives acceptance data Acc1 or the undo command Und and transmits the acceptance data Acc1 or the undo command Und to the component 120. For example, the user of the data processing system inputs the acceptance data Acc1 or the undo command Und. Step S9 and Step S10 correspond to a portion surrounded by a rectangle alt in FIG. 18, and the operation at the time of receiving the undo command Und corresponds to an arrow extending from (9) and an arrow extending from (10) in FIG. 18. The operation at the time of receiving the acceptance data Acc1 corresponds to an arrow extending from (11) and an arrow extending from (12).

### <<Step S10>

When the component 120 receives the acceptance data Acc1 in Step S10 of Phase PH2, Phase PH2 ends. When the component 120 receives the undo command Und, the process proceeds to Step S1 of Phase PH2.

Thus, the part Prt can be extracted from the patent application document PAD_1 with the use of the range data Rng. In addition, the summary Sum can be generated from the extracted part Prt. For another example, the summary Sum can be generated from the part Prt extracted from a portion to which decoration or annotation is not given. Moreover, the summary Sum can be generated from description other than the description of the special technical feature STF_1 of the scope of the granted patent claims ACL_1. As a result, a novel data processing system that is highly convenient, useful, or reliable can be provided.

### Example 3 of Data Processing Method

Another data processing method of one embodiment of the present invention includes Phase PH1, Phase PH2, and Phase PH3 (see FIG. 16 and FIG. 19).

### Example of Phase PH3

Phase PH3 follows Phase PH2, and includes Step S1 to Step S9 (see FIG. 16).

### <<Step S1>>

In Step S1 of Phase PH3, the subcomponent 120B creates the prompt Pt31 and transmits it to the component 130. The prompt Pt31 includes the instruction g31( ), the special technical feature STF_1, the description of the special technical feature TXT_STF1, and the part Prt. The instruction g31( ) includes the procedure for generating the claim draft DC from the special technical feature STF_1, the description of the special technical feature TXT_STF1, and the part Prt. Step S1 corresponds to an arrow extending from (1) and an arrow extending from (2) in FIG. 19.

### <<Step S2>>

In Step S2 of Phase PH3, the component 130 receives the prompt Pt31 or the prompt Pt32 and generates the claim draft DC with the use of the large language model LLM.

### <<Step S3>>

In Step S3 of Phase PH3, the component 130 transmits the claim draft DC to the component 120. Step S3 corresponds to an arrow extending from (3) in FIG. 19.

### <<Step S4>>

In Step S4 of Phase PH3, the component 120 receives the claim draft DC and transmits it to the component 110. Step S4 corresponds to an arrow extending from (4) in FIG. 19. Step S4 to Step S8 correspond to a portion surrounded by the rectangle loop in FIG. 19.

### <<Step S5>>

In Step S5 of Phase PH3, the component 110 receives the claim draft DC and provides it to the user of the data processing system, for example. Step S5 corresponds to an arrow extending from (5) in FIG. 19.

### <<Step S6>>

In Step S6 of Phase PH3, the component 110 receives the acceptance data Acc2 or the requirement Req and transmits the acceptance data Acc2 or the requirement Req to the component 120. For example, the user of the data processing system inputs the acceptance data Acc2 or the requirement Req. Step S6 to Step S8 correspond to a portion surrounded by the rectangle alt in FIG. 19, and the operation at the time of receiving the requirement Req corresponds to an arrow extending from (6) and an arrow extending from (7) in FIG. 19. The operation at the time of receiving the acceptance data Acc2 corresponds to an arrow extending from (11) and an arrow extending from (12).

### <<Step S7>>

When the component 120 receives the acceptance data Acc2 in Step S7 of Phase PH3, Phase PH3 ends. When the component 120 receives the requirement Req, the subcomponent 120B creates the prompt Pt32 and transmits it to the component 130. The prompt Pt32 includes the instruction g32( ), the requirement Req, the special technical feature STF_1, the description of the special technical feature TXT_STF1, and the part Prt. The instruction g32( ) includes the procedure for generating the claim draft DC from the requirement Req, the special technical feature STF_1, the description of the special technical feature TXT_STF1, and the part Prt. Step S7 corresponds to an arrow extending from (8) and an arrow extending from (9) in FIG. 19.

### <<Step S8>>

In Step S8 of Phase PH3, the component 130 receives the prompt Pt32 and generates the claim draft DC with the use of the large language model LLM.

### <<Step S9>>

In Step S9 of Phase PH3, the component 130 transmits the claim draft DC to the component 120, and the process proceeds to Step S4 of Phase PH3. Step S9 corresponds to an arrow extending from (10) in FIG. 19.

Thus, the claim draft DC can be generated using the special technical feature STF_1 of the scope of the granted patent claims ACL_1 and the summary Sum. For example, the user of the data processing system can examine the claim draft DC and add the requirement Req. The claim draft DC can be generated by adding the requirement Req to the special technical feature STF_1 of the scope of the granted patent claims ACL_1, the description of the special technical feature TXT_STF1, and the part Prt. As a result, a novel data processing method that is highly convenient, useful, or reliable can be provided.

Note that this embodiment can be combined with the other embodiment in this specification as appropriate.

This application is based on Japanese Patent Application Serial No. 2024-153587 filed with Japan Patent Office on Sep. 6, 2024, the entire contents of which are hereby incorporated by reference.

What is claimed is:

1. A data processing system comprising:
a first component;
a second component; and
a third component,
wherein the first component is configured to receive identification data and transmit the identification data to the third component and is configured to receive and provide an annotated document,
wherein the identification data comprises data specifying one of patent applications,
wherein the second component is configured to receive a first prompt and transmit a special technical feature to the third component, is configured to receive a second prompt and transmit the annotated document to the third component, and is configured to perform processing using a large language model,
wherein the large language model is configured to extract the special technical feature in accordance with the first prompt and is configured to generate the annotated document in accordance with the second prompt,
wherein the third component is configured to receive the identification data and the special technical feature and share the identification data and the special technical feature in the third component, is configured to create a table and share the table in the third component, is configured to create the first prompt and the second prompt and transmit the first prompt and the second prompt to the second component, and is configured to receive the annotated document and transmit the annotated document to the first component,
wherein the third component comprises a first subcomponent and a second subcomponent,
wherein the first subcomponent is configured to perform processing using a database and a management system,
wherein the database comprises at least one patent application document and at least one examination record,
wherein the examination record comprises a notice of reasons for refusal and an argument,
wherein the management system is configured to create the table from the database in accordance with a query,
wherein the table comprises the patent application document, a scope of granted patent claims of the patent application document, and the examination record of the scope of the granted patent claims,
wherein the query comprises the identification data,
wherein the query requests that an original application of the patent application document is identical to an original application of a patent application specified by the identification data,
wherein the second subcomponent is configured to create the first prompt and the second prompt,
wherein the first prompt comprises a first instruction and the table,
wherein the first instruction comprises a procedure for extracting the special technical feature of the scope of the granted patent claims from the table,
wherein the second prompt comprises a second instruction, the special technical feature, and the patent application document, and
wherein the second instruction comprises a procedure for generating the annotated document by giving decoration or annotation to description of the special technical feature in the patent application document.

2. The data processing system according to claim 1,
wherein the first component is configured to receive range data and transmit the range data to the third component and is configured to receive and provide a summary,
wherein the range data specifies a portion of the patent application document,
wherein the second component is configured to receive a third prompt and transmit the summary to the third component,
wherein the large language model is configured to generate the summary in accordance with the third prompt,
wherein the third component is configured to receive the range data and share the range data in the third component, is configured to transmit the third prompt to the second component, and is configured to receive the summary and transmit the summary to the first component,
wherein the third component comprises a third subcomponent,
wherein the third subcomponent is configured to extract a part from the patent application document on the basis of the range data,
wherein the second subcomponent is configured to create the third prompt,
wherein the third prompt comprises a third instruction and the part, and
wherein the third instruction comprises a procedure for generating the summary from the part.

3. The data processing system according to claim 2, wherein the first component is configured to receive an undo command and provide the annotated document.

4. The data processing system according to claim 2,
wherein the first component is configured to receive acceptance data and transmit the acceptance data to the third component and is configured to receive and provide a claim draft,
wherein the second component is configured to receive a fourth prompt and transmit the claim draft to the third component,
wherein the large language model is configured to generate the claim draft in accordance with the fourth prompt,
wherein the third component is configured to receive the acceptance data and share the acceptance data in the third component, is configured to transmit the fourth prompt to the second component, and is configured to receive the claim draft and transmit the claim draft to the first component,
wherein the second subcomponent is configured to create the fourth prompt,
wherein the fourth prompt comprises a fourth instruction, the special technical feature, the description of the special technical feature, and the part, and
wherein the fourth instruction comprises a procedure for generating the claim draft from the special technical feature, the description of the special technical feature, and the part.

5. The data processing system according to claim 4,
wherein the first component is configured to receive a requirement and transmit the requirement to the third component,
wherein the second component is configured to receive a fifth prompt and transmit the claim draft to the third component,
wherein the large language model is configured to generate the claim draft in accordance with the fifth prompt,
wherein the third component is configured to receive the requirement and share the requirement in the third component and is configured to transmit the fifth prompt to the second component,
wherein the second subcomponent is configured to create the fifth prompt,
wherein the fifth prompt comprises a fifth instruction, the requirement, the special technical feature, the description of the special technical feature, and the part, and
wherein the fifth instruction comprises a procedure for generating the claim draft from the requirement, the special technical feature, the description of the special technical feature, and the part.

6. The data processing system according to claim 1,
wherein the first component comprises a display device,
wherein the display device is configured to display the annotated document, and
wherein the description of the special technical feature in the annotated document is displayed while being given with annotation or decoration using at least one of a highlight, a bold letter, an italic letter, and an underline.

7. The data processing system according to claim 2,
wherein the first component comprises a display device and an input device,
wherein the display device is configured to display the annotated document and a pointer,
wherein the description of the special technical feature in the annotated document is displayed while being given with annotation or decoration using at least one of a highlight, a bold letter, an italic letter, and an underline, and
wherein the input device is configured to move the pointer and is configured to input the range data.

8. The data processing system according to claim 1,
wherein the first component, the second component, and the third component each comprise an arithmetic device and a communication device, and
wherein the communication devices are connected to each other via a network.

9. A data processing method comprising:
a first phase,
wherein the first phase comprises a first step, a second step, a third step, a fourth step, a fifth step, a sixth step, a seventh step, an eighth step, a ninth step, a tenth step, an eleventh step, and a twelfth step,
wherein, in the first step of the first phase, a first component receives identification data and transmits the identification data to a second component,
wherein, in the second step of the first phase, the second component receives the identification data and shares the identification data in the second component,
wherein the second component comprises a first subcomponent and a second subcomponent,
wherein the first subcomponent is configured to perform processing using a database and a management system,
wherein the database comprises a patent application document and an examination record,
wherein the examination record comprises a notice of reasons for refusal and an argument,
wherein, in the third step of the first phase, the first subcomponent creates a table from the database in accordance with a query with use of the management system and shares the table in the second component,
wherein the table comprises the patent application document, a scope of granted patent claims of the patent application document, and the examination record of the scope of the granted patent claims,
wherein the query comprises the identification data,
wherein the query requests that an original application of the patent application document is identical to an original application of a patent application specified by the identification data,
wherein, in the fourth step of the first phase, the second subcomponent creates a first prompt and transmits the first prompt to a third component,
wherein the first prompt comprises a first instruction and the table,
wherein the first instruction comprises a procedure for extracting a special technical feature of the scope of the granted patent claims from the table,
wherein, in the fifth step of the first phase, the third component receives the first prompt and extracts the special technical feature with use of a large language model,
wherein, in the sixth step of the first phase, the third component transmits the special technical feature to the second component,
wherein, in the seventh step of the first phase, the second component receives the special technical feature and shares the special technical feature in the second component,
wherein, in the eighth step of the first phase, the second subcomponent creates a second prompt and transmits the second prompt to the third component,
wherein the second prompt comprises a second instruction, the special technical feature, and the patent application document,
wherein the second instruction comprises a procedure for generating an annotated document by giving decoration or annotation to description of the special technical feature in the patent application document,
wherein, in the ninth step of the first phase, the third component receives the second prompt and generates the annotated document with use of the large language model,
wherein, in the tenth step of the first phase, the third component transmits the annotated document to the second component,
wherein, in the eleventh step of the first phase, the second component receives the annotated document and transmits the annotated document to the first component, and
wherein, in the twelfth step of the first phase, the first component receives and provides the annotated document.

10. The data processing method according to claim 9, further comprising a second phase,
wherein the second phase follows the first phase,
wherein the second phase comprises a first step, a second step, a third step, a fourth step, a fifth step, a sixth step, a seventh step, an eighth step, a ninth step, and a tenth step,
wherein, in the first step of the second phase, the first component receives range data and transmits the range data to the second component,
wherein the range data specifies a portion of the patent application document,
wherein, in the second step of the second phase, the second component receives the range data and shares the range data in the second component,
wherein the second component comprises a third subcomponent,
wherein, in the third step of the second phase, the third subcomponent extracts a part from the patent application document on the basis of the range data,
wherein, in the fourth step of the second phase, the second subcomponent creates a third prompt and transmits the third prompt to the third component,
wherein the third prompt comprises a third instruction and the part,
wherein the third instruction comprises a procedure for generating a summary from the part,
wherein, in the fifth step of the second phase, the third component receives the third prompt and generates the summary with use of the large language model,
wherein, in the sixth step of the second phase, the third component transmits the summary to the second component,
wherein, in the seventh step of the second phase, the second component receives the summary and transmits the summary to the first component,
wherein, in the eighth step of the second phase, the first component receives and provides the summary,
wherein, in the ninth step of the second phase, the first component receives first acceptance data or an undo command and transmits the first acceptance data or the undo command to the second component, and
wherein, in the tenth step of the second phase, the second phase ends when the second component receives the first acceptance data, and a process proceeds to the first step of the second phase when the second component receives the undo command.

11. The data processing method according to claim 10, further comprising a third phase,
wherein the third phase follows the second phase,
wherein the third phase comprises a first step, a second step, a third step, a fourth step, a fifth step, a sixth step, a seventh step, an eighth step, and a ninth step,
wherein, in the first step of the third phase, the second subcomponent creates a fourth prompt and transmits the fourth prompt to the third component,
wherein the fourth prompt comprises a fourth instruction, the special technical feature, the description of the special technical feature, and the part,
wherein the fourth instruction comprises a procedure for generating a claim draft from the special technical feature, the description of the special technical feature, and the part,
wherein, in the second step of the third phase, the third component receives the fourth prompt or a fifth prompt and generates the claim draft with use of the large language model,
wherein, in the third step of the third phase, the third component transmits the claim draft to the second component,
wherein, in the fourth step of the third phase, the second component receives the claim draft and transmits the claim draft to the first component,
wherein, in the fifth step of the third phase, the first component receives and provides the claim draft,
wherein, in the sixth step of the third phase, the first component receives second acceptance data or a requirement and transmits the second acceptance data or the requirement to the second component,
wherein, in the seventh step of the third phase, the third phase ends when the second component receives the second acceptance data, and the second subcomponent creates the fifth prompt and transmits the fifth prompt to the third component when the second component receives the requirement,
wherein the fifth prompt comprises a fifth instruction, the requirement, the special technical feature, the description of the special technical feature, and the part,
wherein the fifth instruction comprises a procedure for generating the claim draft from the requirement, the special technical feature, the description of the special technical feature, and the part,
wherein, in the eighth step of the third phase, the third component receives the fifth prompt and generates the claim draft with use of the large language model, and
wherein, in the ninth step of the third phase, the third component transmits the claim draft to the second component, and a process proceeds to the fourth step of the third phase.
